(19) United States
(12) Patent Application Publication
(10) Pub. No.: US 2006/0168123 A1
(43) Pub. Date: Jul. 27, 2006

(54) Queue and load for wireless hotspots

(75) Inventor: Zlatko Krstulich, Ottawa (CA)

Correspondence Address: KRAMER & AMADO, P.C., 1725 DUKE STREET, SUITE 240, ALEXANDRIA, VA, 22314, US

(73) Assignee: ALCATEL, Paris (FR)

(21) Appl. No.: 11/010,304

(22) Filed: Dec. 14, 2004

(51) Int. Cl. G06F 15/16

(52) U.S. Cl. 709/219; 709/203

(57) ABSTRACT

A system and method are provided for queuing and downloading content from a network. A user browses a network for content, and informs a scheduler of desired content and download parameters, such as a target end user device and conditions that are to be met before downloading occurs. The scheduler stores the requested content until the target end user device is available and the conditions are satisfied, at which point the content is downloaded to the target end user device. The invention allows a user to browse for content at one point in time and using one device, and to have the content downloaded at a later point in time and possibly to a different device. This allows, for example, the user to browse for content during high cost access times and to retrieve large files during low cost access times.

### FIELD OF THE INVENTION

The invention relates to multi-modal content distribution in telecommunications networks, and more particularly to deferred or redirected downloading of content.

### BACKGROUND OF THE INVENTION

Generally, users of mobile connected devices, such as cellular phones, do not enjoy the same cost-effective and timely downloading capabilities from the Internet as do users of fixed access devices. There is a wide variety of content available from content providers over the Internet, such as e-newspapers, videos, music, and e-magazines. Most of this multimedia content is too large to be effectively downloaded into most mobile connected devices, even 3G devices. This is due to a mix of factors, including relatively low bandwidth and resultant long download times, high bandwidth cost, and mismatches between file requirements and storage and presentation capabilities of the user's mobile device.

One approach is to use a cellular phone network to download content to a laptop computer over a wireless data connection. This approach is slow and expensive, even using faster connections envisioned with 3G technologies.

The wide deployment of wireless “hotspots” (typically provided by 802.11 WiFi, WiMAX, or other technologies) provides adequate high speed wireless data connections for most download requirements. The cost is often reasonable, and such services often provide for a flat rate fee independent of the quantity of data transferred. However, the geographic coverage of hotspots does not match the ubiquity of wireless networks, with hotspots tending to be limited to public transit areas such as airports and train stations. A mobile user may not have the time or the inclination to browse content providers' websites to select and download content of interest, if such activities need to be restricted to hotspots only or only when the user is at home.

A system which allowed users to browse through and select digital content anywhere, taking advantage of the near-ubiquitous coverage of today's mobility networks based on GSM or CDMA, while providing flexibility as to the target device accepting the download, would provide improved means for mobile users to conveniently and cost-effectively download content from service providers.

### SUMMARY OF THE INVENTION

In accordance with one aspect of the invention, a method is provided for performing context redirection of download requests. A download request is received from a requesting device over a request context. A download context is received from the requesting device, the download context differing from the request context. Content identified in the download request is retrieved, and downloaded to a target device over the download context. The download context may differ from the request context in that the target device is a different physical device from the requesting device, the content is downloaded over a different service type than that over which the download request is received, or that a download policy specified in the download request must be satisfied before the content is downloaded to the target device.

Apparatus is provided for implementing the methods of the invention. The methods of the invention may be stored as instructions on a computer-readable medium, the instructions being executable by a computer processor.

The methods and apparatus provide context redirection of download requests, de-coupling the request for content from the download of the content by redirecting requested content to a target device different from that from which the request is made or by deferring downloading of requested content until the target device (possibly the device from which the request is made) is connected to the network through a more desirable connection. In either case, the download request is stored until a more appropriate connection exists for downloading the requested content. This allows more convenient and cost effective downloading of content by a user. The user can queue a request for downloading content, which allows the user to browse for content during high cost or low bandwidth access to the network, and then have the content downloaded later when low cost or high bandwidth access to the network is available, in a manner transparent to the user. The user can also, or alternatively, specify a different target end user device, allowing the user to browse for content using a low storage capacity device such as a PDA or even a cell phone, and to download the content to a device having larger storage such as a home computer. If the requesting device is a multi-modal device, the target device may also be the same as the requesting device but a different connection mode is used for downloading the content than from requesting the content.

### BRIEF DESCRIPTION OF THE DRAWINGS

The features and advantages of the invention will become more apparent from the following detailed description of the preferred embodiment(s) with reference to the attached figures, wherein:

FIG. 1 is a block diagram of an example store-and-forward telecommunications system according to one embodiment of the invention;

FIG. 2 is a flow chart of a method by which download requests are stored and processed according to one embodiment of the invention; and

FIG. 3 is a flowchart of a method by which content is downloaded according to one embodiment of the invention.

It will be noted that in the attached figures, like features bear similar labels.

### DETAILED DESCRIPTION OF THE EMBODIMENTS

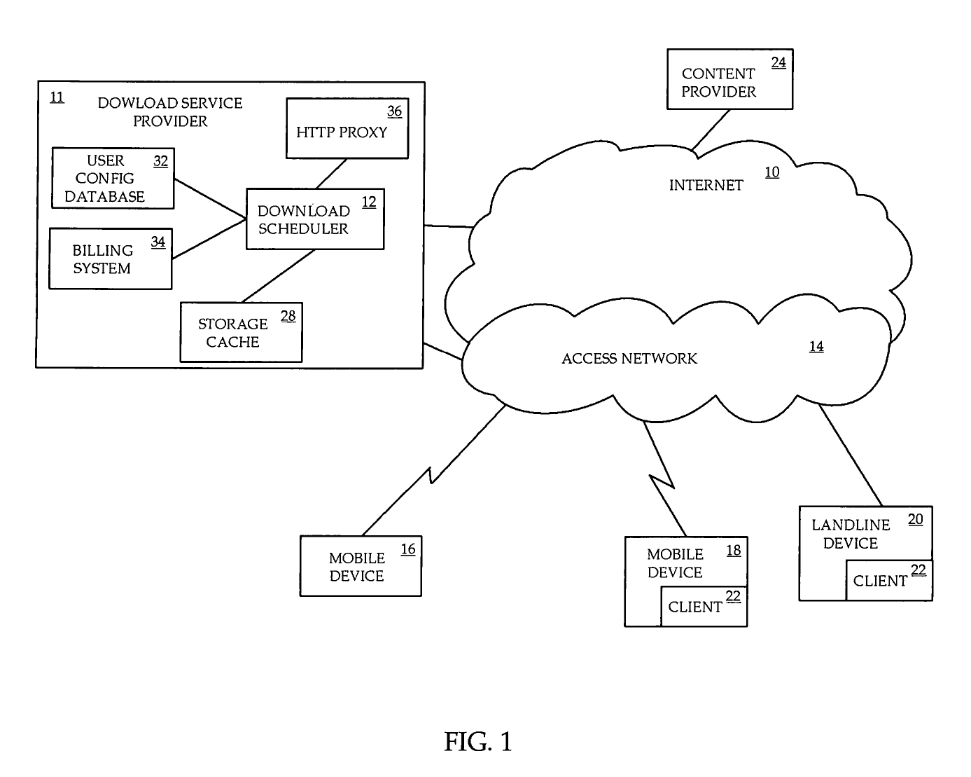

Referring to FIG. 1, an example store-and-forward telecommunications system according to one embodiment of the invention is shown. A download service provider 11 is connected to a network 10, such as the Internet. Within the network 10, a plurality of access networks 14 provide network access to end user devices. The download service provider 11 may also operate an access network within the plurality of access networks 14. In the example system shown in FIG. 1, the end user devices include a first mobile device 16, a second mobile device 18, and a fixed device 20. Of course any combination of end user devices may be possible.

An end user device may be any device capable of interacting with the content provider 24 via a proxy 36 within the download service provider 11 to request or retrieve content, such as a portable computer, a desktop computer, or a personal digital assistant. End user devices which are used to request content are referred to herein as requesting devices and include means for browsing for content, such as a web browser. End user devices to which content will be downloaded (the mobile device 18 and the landline device 20 in the example shown in FIG. 1) are referred to herein as target devices. A target device is defined by the physical end user device and a communication service or protocol. In the case of a multi-modal end user device, therefore, a single physical device may include more than one target device. Each target device includes a pull client 22. Each pull client 22 allows content to be downloaded to the corresponding target device when the download is initiated by the download service provider 10. The pull client is provided by the download service provider 10 and installed by the user once, and is configured to recognize and authorize subsequent download attempts by the download service provider 10.

A plurality of content providers 24 are in communication with the network 10 (although only one is shown in FIG. 1). The download service provider includes a download scheduler 12, a content storage cache 28, a user configuration database 32, a billing system 34, and the HTTP proxy 36. The user configuration database 32 stores customer information for each user, including a list of target devices, of capacities of the target devices, and authentication codes of the target devices which permit downloading of content to the target devices by authentication by the respective pull clients 22. The billing system 34 includes information related to charging the user for the queue and load service provided by the download scheduler 12. Within the download service provider 11, the download scheduler 12 is in communication with each of the other components.

The end user devices may only be in communication with the access network 14 temporarily. Examples of temporary communications include an end user device being turned off or on, and a mobile device passing through a wireless “hot spot”.

Broadly, in operation a user accesses the download scheduler 12 using a requesting device and requests content accessible via the network 10, such as at a content provider 24. The user also specifies a target device, and may optionally specify a download policy. Download policies are conditions that must be satisfied before requested content is downloaded, and are explained in more detail below. The download scheduler 12 retrieves and stores the requested content in the storage cache 28. When the target device is next in communication with the network, and optionally when the specified download policies are satisfied, the download scheduler 26 transfers the requested content to the target device. The identification of a target device, which may be different from the end user device from which the content is requested, and the download policies each, or together, define a download context. Context redirection of the download request occurs in that content is not merely downloaded to the requesting device immediately upon making the request. Rather, downloading of the content is decoupled from the request and redirected to a separate download context, such as a different physical device, a different communication service within the physical device from which the request is made, or to the same physical device from which the request is made but at a later point in time when specified download policies are satisfied.

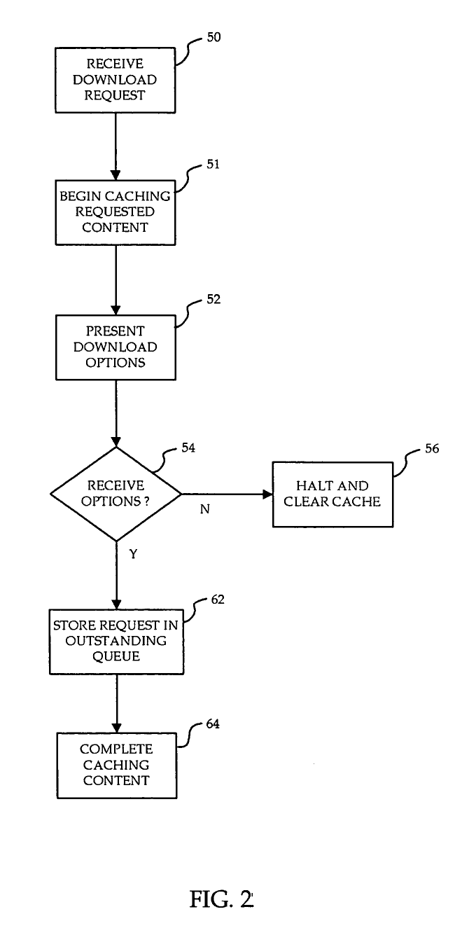

Referring to FIG. 2, a flow chart of a method by which download requests are stored and processed according to one embodiment of the invention is shown. At step 50 the download scheduler 12 receives a download request from a requesting device.

The download request has an associated request context. The request context is an abstraction like the download context, but is defined merely in terms of the requesting device and the communication service if the requesting device is a multi-modal end user device. The content specified by the download request may be any content accessible within or via the network 10, such as a music file, a video file, an image file, or a data file of any other format.

The download request is received when a user browsing through the HTTP proxy 36 for content provided by a content provider 24 completes a sequence of interactions required by the content provider's interface (such as a web interface) to initiate a download. The HTTP proxy 36 identifies the resulting traffic stream as a download event and at step 51 begins caching the requested content in the content storage cache 28. The user may be informed at this point that caching has begun, for example by means of a pop-up window.

At step 52 the download scheduler 12 consults the user configuration database 32 and retrieves a set of download options configured for the user requesting the content. The download options include a set of at least one eligible target device. Each eligible target device is an end user device to which the user may want the content to be downloaded, and need not be the same end user device as the requesting device. The set of eligible target devices also distinguishes between services on multi-modal devices, so that an individual physical device may be included in the set of eligible devices more than once. This also applies to different services on a multi-modal requesting device. The target device may also be a network mail server, as identified by an e-mail address specified by the user.

The download options may also include download policies, each download policy being a set of at least one condition, pre-configured by the user, which must be satisfied before content will be downloaded to a particular target device. Examples of such conditions are time of day, bandwidth availability, preferred target download device, priority relative to other download requests, and cost of available bandwidth.

The download scheduler 12 presents the download options to the user, such as by presenting a menu on a mobile phone display or on a personal digital assistant display. The download scheduler 12 may also calculate and present an estimate of the cost associated with each or some of the download options. At step 54 the user either selects a download option, accepts a default download option, or cancels the download request. If the user cancels the download request, then at step 56 the download scheduler ends processing of the download request, halting the caching of the requested content and clearing the cache. If the user selects a download option, then at step 64 the HTTP proxy 36 completes downloading and caching of the content to the content storage cache 28. At step 66 download scheduler 26 determines whether the target device is an e-mail address. If the target device is an e-mail address, then at step 68 the download scheduler 26 sends the requested content stored in the content storage cache 28 as an attachment to the specified e-mail address, clears the content from the content storage cache 28, and informs the billing system 24 of the transaction. If the target device is not an e-mail address, then at step 70 the download scheduler 26 adds the download option, which includes a target device and optionally a download policy, to the download request and stores the download request within an outstanding request queue. The outstanding request queue may be either a queue of requested downloads for all users and target devices, a queue specific to the requesting user, or a queue specific to the target device.

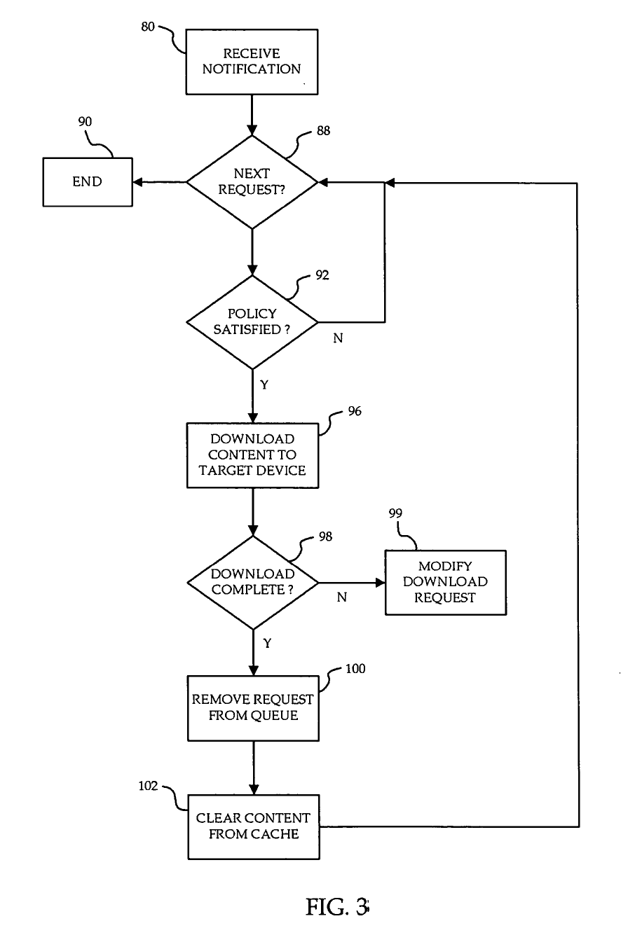

Referring to FIG. 3, a flowchart of a method by which content for a download request is downloaded to end user devices according to one embodiment of the invention is shown. The method is triggered at step 80 when the download scheduler learns that a target device is connected to the access network 14. In the preferred embodiment, end user devices registered with the download service ping the download service provider at regular intervals when connected to the access network 14. This not only informs the download service provider that the end user device is in communication with the network 14, but also informs the download service provider of how the end user device can be reached.

At step 88 the download scheduler 12 attempts to locate a download request associated with the target device within the outstanding queue. If the download scheduler 12 can not locate any download requests associated with the target device, then at step 90 the download scheduler terminates processing of download requests for the target device. If the download scheduler 12 locates a download request associated with the target device, then at step 92 the download scheduler determines whether the download request includes a download policy, and if so, whether the set of at least one appropriate condition specified in the download policy is satisfied. As examples, and depending on what conditions were included in the download policy when entered by the user when submitting the download request, the download scheduler may determine whether the connection to the target end user device has sufficient bandwidth, whether it is currently the correct time of day, whether higher priority download requests are in the pending request queue, whether specified download requests have been previously completed, whether the connection to the target device is cost-effective, or any combination of such conditions.

If the download request includes a download policy and if the set of at least one condition specified in the download policy is not satisfied, then the content is not to be downloaded to the target device, and the download scheduler attempts to locate another download request associated with the target device at step 88. If the set of at least one condition specified in the download policy is satisfied or if the download request does not include a download policy, then at step 96 the download scheduler retrieves the content associated with the download request and stored in the content storage cache 28, and downloads the content to the target device. The download to the target device is authenticated by use of the pull client 22 of the target device, and the authentication code for the target device which is stored in the user configuration database 32. When downloading terminates, the download scheduler determines whether the download was complete at step 98. The download may not be complete if, for example, the target device ended the connection before all of the content was downloaded, as may occur if a user is passing through a WiFi hotspot. If the download was not complete, then at step 99 the download scheduler modifies the download request stored in the outstanding queue to indicate how much of the content was downloaded successfully.

If the download scheduler determines at step 98 that the download was complete, then the download scheduler removes the download request from the outstanding queue at step 100, and removes the associated content from the content storage cache 28 at step 102. The download scheduler informs the billing system 34 of the successful transaction, and attempts to locate another download request associated with the target device at step 88.

The operation of the invention will be further explained by means of an example operation described with reference to FIG. 1. A user browses the network (for example, the World Wide Web) using a personal digital assistant (PDA) 16 equipped with a web browser, and selects a text document and a series of music files for downloading. Because of limitations of the storage capacity of the PDA, the expense of using a wireless connection, and the short time that the user has available for being connected to the network 14, the user does not wish to download the content at this time. The user has time to browse for content but not to download content.

The user completes the series of interactions required by the content provider's web interface to initiate the downloads, and the HTTP proxy 36 commences caching the requested content as described above. Upon receiving notification that the downloads are in progress, the user specifies that the text document is to be downloaded to his or her WiFi enabled laptop computer 18 and that the music files are to be downloaded to his or her home computer 20. The user specifies as a download policy for the text document that downloading is to occur when the laptop is within a wireless hotspot. The user specifies no download policy for the music files. The HTTP proxy 36 completes downloading the text document and the music files from content providers 24 and caches them in the content storage cache 28.

Later that day, the user passes through a WiFi hotspot. The download scheduler 12 is notified that the laptop computer 18 is connected to the network 14 and, since the connection is through a WiFi hotspot, determines that the download policy is satisfied for the text document and downloads the text document to the laptop computer. When the user gets home, the user turns on the home computer 20. The download scheduler is notified that the home computer is connected to the network 14, and downloads the music files to the home computer.

If the home computer is already connected to the network when the user submits the download request to the download scheduler, then the download scheduler will transfer the music files to the home computer before the user reaches home.

In the preferred embodiment, the methods implemented by the download scheduler and described above with reference to FIG. 2 and FIG. 3 are in the form of software within a processor, but may more generally be in the form of any combination of software or hardware, including hardware within an integrated circuit. The processor need not be a single device, but rather the instructions could be located in more than one device, including a distributed system. The methods may be run in parallel on the same or separate processors.

The invention has been described as a download scheduler and method running thereon separate from the content provider 24. This allows the queue and load service of the invention to be provided independently of the content providers 24. The service could be offered by an Internet Service Provider, or by an independent server operator through which the user browses the network. Alternatively, a content provider may provide the service with respect to content offered by the content provider. In such an embodiment, the download scheduler 12 is under administrative control of the content provider, and is accessed by the user when the user peruses the content offered by the content provider 24. No content storage cache 28 or HTTP proxy 36 are necessary, as the download scheduler has direct access to requested content. The steps of retrieving and storing content following receipt of a download request (described above with reference to steps 51 and 64 of FIG. 2) and of removing the content once download is complete (described above with reference to step 102 of FIG. 3) are omitted in such an embodiment. A further advantage of implementing the download service provider within the content provider is that digital rights management policies can be enforced. In such an embodiment, the user configuration database 32 stores digital rights management information of each user, such as which content or how many copies of the content each user has been authorized by the content provider to download. After a user submits a download request but before the user is presented with download options (as described above with reference to step 54 of FIG. 2), the download scheduler determines whether downloading the content specified in the download request would violate digital right management policies associated with the requesting user. If such policies would not be satisfied, then the download is denied and the user is notified of such.

The invention has been described as presenting pre-configured download options to the user. Alternatively, the user may specify the target device without the aid of a menu of pre-configured eligible target devices. Similarly, the user may specify download policies without the aid of a menu of pre-configured download policies, or with a more limited menu. However, while providing more flexibility to the user, such an embodiment is limited by the display capabilities of the requesting device and by the amount of time available to the user, and the flexibility may be more than offset by the inconvenience to the user.

The invention has been described as providing each target device with a pull client which allows automatic authentication of download attempts from the download scheduler to the target device. This allows the download scheduler to initiate the download of the requested content without interaction by the user. Alternatively, the target devices could not include pull clients. Rather, the download scheduler sends a message (such as an e-mail message) to the target device indicating that content is ready for download. Upon receiving such a message, the user initiates download of the content by signaling to the download scheduler. However, while in some ways more secure than use of a pull client while still providing context redirection of download requests, such an embodiment requires interaction by the user.

The embodiments presented are exemplary only and persons skilled in the art would appreciate that variations to the embodiments described above may be made without departing from the spirit of the invention. Methods that are logically equivalent or similar to the method described above with reference to FIG. 2 and FIG. 3 may be used to implement the methods of the invention. The scope of the invention is solely defined by the appended claims.

1. A method of performing context redirection of download requests, comprising the steps of:
receiving a download request from a requesting device over a request context;
receiving a download context from the requesting device, the download context differing from the request context;
retrieving content identified in the download request; and
downloading the content to a target device over the download context.

2. The method of claim 1 wherein the download context differs from the request context in that the target device is a different physical device from the requesting device.

3. The method of claim 1 wherein the download context differs from the request context in that the content is downloaded over a different service type than that over which the download request is received.

4. The method of claim 1 wherein the download context differs from the request context in that the download context specifies a download policy that must be satisfied before the content is downloaded to the target device.

5. The method of claim 4 wherein the download policy includes at least one condition, wherein the download policy is satisfied only if each of the at least one condition is satisfied.

6. The method of claim 5 wherein at least one of the at least one condition is one of time of day, bandwidth availability, priority relative to other download requests, and cost of available bandwidth.

7. The method of claim 1 further comprising presenting a menu of download contexts on the requesting device, and wherein receiving a download context comprises receiving a selection from the menu.

8. The method of claim 1 further comprising the steps of:
providing a pull client on the target device;
storing an authentication code associated with a user of the target device; and
prior to downloading the content, authenticating the download with the pull client using the authentication code.

9. The method of claim 1 wherein retrieving content comprises performing a proxy download of the content.

10. A download scheduler for performing context redirection of download requests, comprising:
instructions for receiving a download request from a requesting device over a request context;
instructions for receiving a download context from the requesting device, the download context differing from the request context;
instructions for retrieving content identified in the download request; and
instructions for downloading the content to a target device over the download context.

11. The download scheduler of claim 10 wherein the download context differs from the request context in that the target device is a different physical device from the requesting device.

12. The download scheduler of claim 10 wherein the download context differs from the request context in that the content is downloaded over a different service type than that over which the download request is received.

13. The download scheduler of claim 10 wherein the download context differs from the request context in that the download context specifies a download policy that must be satisfied before the content is downloaded to the target device.

14. The download scheduler of claim 13 wherein the download policy includes at least one condition, wherein the download policy is satisfied only if each of the at least one condition is satisfied.

15. The download scheduler of claim 14 wherein at least one of the at least one condition is one of time of day, bandwidth availability, priority relative to other download requests, and cost of available bandwidth.

16. The download scheduler of claim 10 further comprising instructions for presenting a menu of download contexts on the requesting device, and wherein the instructions for receiving a download context comprise instructions for receiving a selection from the menu.

17. The download scheduler of claim 10 further comprising:
instructions for retrieving an authentication code associated with a user of the target device; and
instructions for, prior to downloading the content, authenticating the download with a pull client of the target device using the authentication code

18. The download scheduler of claim 10 wherein the instructions for retrieving content comprise instructions for performing a proxy download of the content from a content provider under a different administrative control from that of the download scheduler.

19. A computer-readable medium storing instructions for performing context redirection of download requests, comprising:
instructions for receiving a download request from a requesting device over a request context;
instructions for receiving a download context from the requesting device, the download context differing from the request context;
instructions for retrieving content identified in the download request; and
instructions for downloading the content to a target device over the download context.

20. The computer-readable medium of claim 19 wherein the download context differs from the request context in that the target device is a different physical device from the requesting device.

21. The download scheduler of claim 19 wherein the download context differs from the request context in that the content is downloaded over a different service type than that over which the download request is received.

22. The computer-readable medium of claim 19 wherein the download context differs from the request context in that the download context specifies a download policy that must be satisfied before the content is downloaded to the target device.

23. The computer-readable medium of claim 22 wherein the download policy includes at least one condition, wherein the download policy is satisfied only if each of the at least one condition is satisfied.

24. The computer-readable medium of claim 23 wherein at least one of the at least one condition is one of time of day, bandwidth availability, priority relative to other download requests, and cost of available bandwidth.

25. The computer-readable medium of claim 19 further comprising instructions for presenting a menu of download contexts on the requesting device, and wherein the instructions for receiving a download context comprise instructions for receiving a selection from the menu.

26. The download scheduler of claim 19 further comprising:
instructions for retrieving an authentication code associated with a user of the target device; and
instructions for, prior to downloading the content, authenticating the download with a pull client of the target device using the authentication code

27. The download scheduler of claim 19 wherein the instructions for retrieving content comprise instructions for performing a proxy download of the content from a content provider under a different administrative control from that of the download scheduler.

28. A system for providing queue-and-forward downloading of content, comprising:
means for retrieving content identified by a download request;
a content storage cache for storing content identified by the download request; and
a download scheduler for receiving the download requests from a requesting device and for transferring the content identified by the download request from the content storage cache to a target device, the target device differing from the requesting device in at least one of physical device and type of communication channel between the physical device and the download scheduler.

29. The system of claim 28 wherein the means for retrieving content comprise an HTTP proxy.

30. The system of claim 28 further comprising a user configuration database for storing authentication information such that the download scheduler can transfer the content to the target device by interacting with a pull client within the target device.
